(19) United States
(12) Patent Application Publication
(10) Pub. No.: US 2012/0137239 A1
(43) Pub. Date: May 31, 2012

(54) SYSTEMS AND METHODS FOR MANAGING DRUG THERAPEUTIC CLASS INFORMATION

(75) Inventors: Ann Presley, Knoxville, TN (US); Jennifer C. Ginsberg, Denver, CO (US)

(73) Assignee: McKesson Corporation

(21) Appl. No.: 12/956,596

(22) Filed: Nov. 30, 2010

(51) Int. Cl. G06F 3/048

(52) U.S. Cl. 715/771

(57) ABSTRACT

Systems and methods are described for managing drug therapeutic class information. For each drug, a class describing the drug at a particular level of specificity is indicated for display and/or for use in grouping the respective drug, and a display name is associated with the drug class. Thus, the user is able to select a particular class based on the drug's required mode of action or disease to be treated, and all drugs grouped under that class may be displayed to facilitate the prescribing of drugs to the patient. In addition, a list of drugs taken by the patient pre-admittance and/or a list of drugs taken by the patient during his/her stay at the healthcare facility may be presented to the user in groups according to the indicated class. Thus, the healthcare professional may avoid duplication or omission of drugs to be prescribed to the patient, for example, upon discharge.

### BACKGROUND

There are currently over 150,000 drug preparations currently in use in the field of healthcare, with about 15,000 new mixtures and dosages being added each year. At the same time, each year about 12,000 preparations fall off the list. Thus, the list of drugs that a healthcare professional, such as a physician or pharmacist, must be familiar with is long and ever changing, making it challenging to advise patients and provide them with an effective list of prescriptions that corresponds to the patient's physical condition.

To facilitate the job of healthcare professionals, drugs have been grouped by therapeutic class, taking into account how the medication works and/or what disease is targeted by the drug. For example, the AHFS (American Hospital Formulary Service) Pharmacologic-Therapeutic Classification is a widely used system for grouping drugs with similar pharmacologic, therapeutic, and/or chemical characteristics. The AHFS classification provides a 4-tier hierarchy that includes approximately 30 primary classifications, 183 secondary classifications, 252 tertiary classifications, and 88 quaternary classifications.

Even with the AHFS classifications, however, it is often difficult to identify an appropriate drug to prescribe to a patient. The situation becomes even more complex when a patient has multiple conditions and each condition requires a different type of drug. Accordingly, there is a need in the art for an improved system and method for grouping drugs to allow healthcare providers the ability to make drug selections in a more efficient, accurate, and effective manner.

### BRIEF SUMMARY OF THE INVENTION

Systems, methods, and computer program products are therefore provided for managing drug therapeutic class information. Embodiments of the systems, methods, and computer program products allow users to more efficiently and effectively analyze lists of drugs for prescribing medication to patients, for example.

In one exemplary embodiment, a system for managing drug therapeutic class information is provided. The system includes a processor configured to access drug information stored on a memory, where the drug information describes a plurality of drugs. In this regard, the drug information for each drug includes at least one drug class, each drug class describing the drug at a level of specificity; a display name associated with the drug class; and an indication of a display level. The processor is configured to access the stored drug information and select for display to a user the display name associated with the drug class corresponding to the display level. The indication of the display level for each drug is independent of the indication of the display level for other drugs.

In some embodiments, a user input device is also provided, which is in communication with the processor. The user input device may be configured to receive a requested drug class from the user, and the processor may be configured to select for display to the user drugs for which the display name corresponds to the requested drug class. In addition, a display may be provided that is in communication with the processor. In this case, the processor may be configured to cause display of data upon the display for each selected drug including a drug name and the display name.

The at least one drug class may be based on an American Hospital Formulary Service (AHFS) Pharmacologic-Therapeutic Classification, and the display name may be different from the AHFS Pharmacologic-Therapeutic Classification name of the associated drug class. Also, the drug information for at least one drug may comprise at least two drug classes including a top level class and one or more subclasses, and the indication of a display level at the top level may comprise a lack of indication at the subclass level.

In some cases, the drug information may be stored on a first memory, and the processor may be further configured to access patient information stored on a second memory. The patient information may include a first drug or set of drugs taken by a patient before being admitted to a healthcare facility and/or a second drug or set of drugs taken by the patient while the patient is at the healthcare facility. The processor may be configured to access the stored patient information for a requested patient, compile a list of drugs including at least one of the first drug and the second drug, access the drug information for each drug on the drug list, and cause display of the drug list to a user, including the display name for each drug on the drug list. A user input device in communication with the processor may be provided, where the user input device is configured to receive a patient identifier from the user designating the requested patient. In some cases, the processor may be configured to compile a list of drugs including the first drug(s) and the second drug(s).

In other embodiments, a method and a computer program product are provided for managing drug therapeutic class information that describes a plurality of drugs. For each drug, at least one drug class is provided, where each drug class describes the drug at a level of specificity. The drug class is associated with a display name, and a display level is indicated for each drug. Furthermore, the display name associated with the drug class at the display level is selected for display to a user. The indication of the display level for each drug is independent of the indication of the display level for other drugs.

In some cases, a requested drug class is received from the user, and the user is presented with a list of drugs for which the display name corresponds to the requested drug class. A patient identifier may also be received from the user designating a requested patient, and a list of drugs associated with the requested patient may be compiled, where the drug list includes a first drug taken by the patient before being admitted to a healthcare facility and/or a second drug taken by the patient while the patient is at the healthcare facility.

The user may be presented with the drug list, including a drug name and a display name for each drug on the drug list. Also, drugs on the drug list having a common display level may be identified. In some embodiments, the drug list may include the first drug and the second drug.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts an excerpt of the AHFS tier structure for the drugs celecoxib and aspirin;

FIG. 2 illustrates a typical environment in accordance with one exemplary embodiment of the present invention;

FIG. 3A is a schematic representation of a user station in accordance with one exemplary embodiment of the present invention;

FIG. 3B is a schematic representation of a server in accordance with one exemplary embodiment of the present invention;

FIG. 4 illustrates a database of drug classes structured according to the AHFS Pharmacologic-Therapeutic classes and modified according to an exemplary embodiment of the present invention;

FIG. 5 shows an example of a screen displayed to a user in a Prescription Writer Module according to an exemplary embodiment of the present invention;

FIG. 6 shows an example of a screen displayed to a user in a Medication Reconciliation Module according to an exemplary embodiment of the present invention;

FIG. 7 shows an example of another screen displayed to a user in a Medication Reconciliation Module according to an exemplary embodiment of the present invention;

FIG. 8 shows an example of another screen displayed to a user in a Medication Reconciliation Module according to an exemplary embodiment of the present invention;

FIG. 9 shows an example of another screen displayed to a user in a Medication Reconciliation Module according to an exemplary embodiment of the present invention; and

FIG. 10 is a flow chart illustrating a method of managing drug therapeutic class information according to an exemplary embodiment of the present invention.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout.

The systems and methods of the present invention may be used by healthcare facilities, such as hospitals, physicians' offices, pharmacies, and any other facility that manages and/or prescribes drugs for patient use. The systems and methods described herein provide a more user-friendly and effective way of referencing drug data. In other words, physicians, pharmacists, nurses, and other users may use embodiments of the systems and methods discussed below, for example, to view information regarding a particular drug, to view a list of drugs belonging to a particular class of drugs, and to reconcile two or more lists of drugs to avoid duplications and omissions of drugs, among other uses.

More specifically, one system that is currently widely used to classify drugs is the AHFS (American Hospital Formulary Service) Pharmacologic-Therapeutic Classification system. According to AHFS taxonomy, drugs with similar pharmacologic, therapeutic, and/or chemical characteristics are grouped together under a 4-tier hierarchy. In other words, a primary classification (Tier 1 or top level class) for a particular drug may describe the drug's mode of action or the disease state treated by the drug in a general manner; a secondary classification (Tier 2 or subclass) may describe the same drug in a more specific manner; a tertiary classification (Tier 3 or subclass) may describe the drug in even more specific terms; and a quaternary classification (Tier 4 or subclass) may describe the drug in the most specific manner.

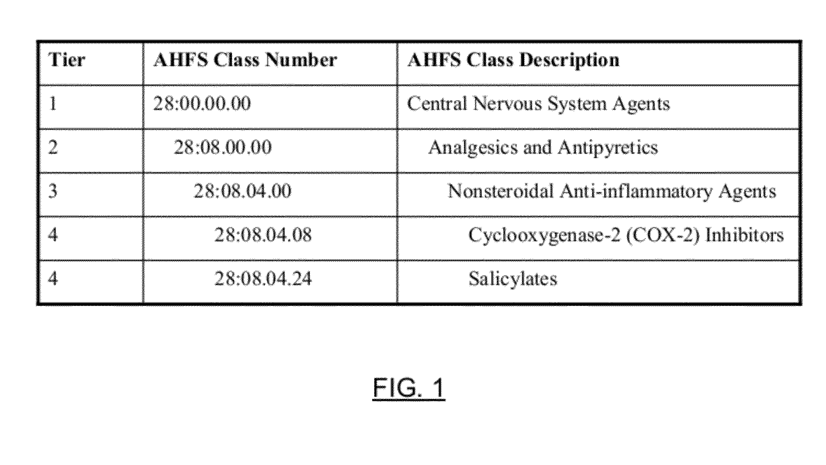

For example, FIG. 1 depicts an excerpt of the tier structure under the AHFS Class for the two drugs, celecoxib and aspirin. Both of these drugs fall under the Tier 1 (top level) class of Central Nervous System Agents, designated by Class Number 28:00.00.00. Under the general heading of Central Nervous System Agents, there may be numerous Tier 2 subclasses. As shown in FIG. 1, both celecoxib and aspirin also share the Tier 2 class Analgesics and Antipyretics, designated by Class Number 28:08.00.00. The two drugs in this example also share the subclass of Nonsteroidal Anti-inflammatory Agents (Class Number 28:08.04.00) at the Tier 3 level. When at the most specific, Tier 4, level of description, however, celecoxib falls under the category of Cyclooxygenase-2 (COX-2) Inhibitors (Class Number 28:08.04.08), and aspirin falls under the Tier 4 category of Salicylates (Class Number 28:08.04.24).

Although the AHFS classification system is widely used, the system presents to users the most specific classification describing the drugs. In other words, the AHFS classification system groups drugs according to the most specific therapeutic class. Alternatively, other systems may group drugs across a more general class or subclass (such as Tier 2), but may apply this level of specificity across all drugs. In this case, for example, many drugs may be listed under certain Tier 2 subclasses that may represent different Tier 3 and/or Tier 4 subclasses, forcing the healthcare professional to analyze more information than necessary.

Using the example described above, celecoxib may be referred to in the healthcare industry as a “Cyclooxygenase-2 (COX-2) Inhibitor,” whereas aspirin may be referred to as a “Salicylate.” Therefore, it may not be readily apparent to a practitioner that both of these drugs are Nonsteroidal Anti-inflammatory Agents and have similar modes of action or indications as they share the same Tier 1, Tier 2, and Tier 3 categories. It may thus be more useful to a practitioner to view the Tier 3 classification for these two drugs, rather than the most specific Tier 4 class. For other drugs, however, referring to the drug by its Tier 4, Tier 2, or even Tier 1 class may be more appropriate, regardless of the specificity of the AHFS taxonomy for the drug.

Another shortfall of classification systems such as the AHFS system is that the name given to a class at a particular level of specificity may not necessarily be the name used or easily recognized by healthcare professionals. For example, the drug Enbrel®, a drug used to treat rheumatoid arthritis, is classified under the AHFS system as 92:36, as follows:

| Tier | Class Number | Class Name |
|---|---|---|
| 1 | 92 | Disease Modifying Anti-rheumatic |
| | | Agents |
| 2 | 36 | Anti-inflammatory Tumor |
| | | Necrosis Factor Inhibiting Agents |

As shown in the table above, Enbrel® is classified using only two of the four available tiers under AHFS. Although the official AHFS name for the Tier 2 class is “Anti-inflammatory Tumor Necrosis Factor Inhibiting Agents,” this class is commonly referenced by practitioners as “TNF Alpha Sel.”

In some cases, according to the AHFS classification system, a drug may fall under multiple classes, either as a result of its indication, mechanism of action, or route of administration. In such a situation, the provider or administrator of the database described below may choose one of the classes, such as the most commonly used class, as the appropriate class for describing the respective drug.

Embodiments of the systems and methods described below aim to facilitate a practitioner's ability to reference drug therapeutic class information by grouping drugs according to the drug's most appropriate classification level. In other words, using the framework of a classification system such as the AHFS system, each drug is described by one or more drug classes, and a display name is associated with each drug class. A display level is indicated for each drug, representing one of its drug classes as being most appropriate for display to a user, as determined by the medical field, a particular practice field (e.g., pediatrics), or the user (e.g., a particular hospital, hospital administrator, or physician). In some cases, the display name may be identical to the drug class (e.g., the official AHFS class name), whereas in other cases a simplified or more user-friendly name may be defined.

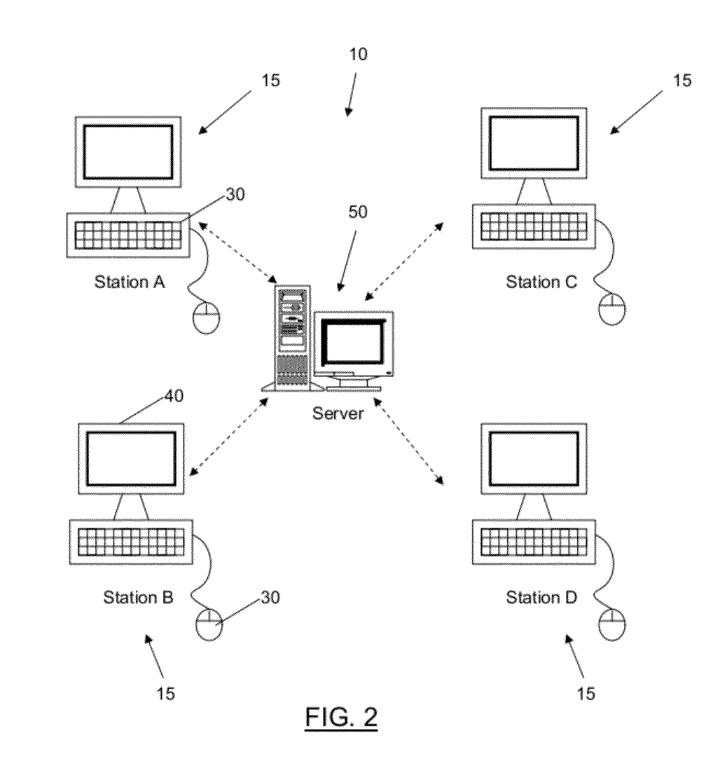

FIG. 2 illustrates an example of a typical environment in which the systems and methods of embodiments of the present invention may operate. For the purposes of explanation, the environment will be described in terms of a hospital setting, although it is understood that the systems and methods of embodiments of the present invention may be used in any setting where drugs are handled, supplied, and/or dispensed.

A system 10 is shown in FIG. 2 that typically includes one or more stations 15, where physicians, physician's assistants, nurses, pharmacists, pharmacy technicians, and other healthcare professionals can access information such as information regarding a particular patient, a listing of drugs for prescribing to a patient, and/or a listing of drugs that have been prescribed to a particular patient. For example, in FIG. 2, four stations are shown: Station A, Station B, Station C, and Station D. Thus, depending on the size and type of healthcare facility, the facility may have any number of stations 15 as necessary to meet the needs of the particular facility. For example, the facility may have 1, 10, 50, or 100 stations.

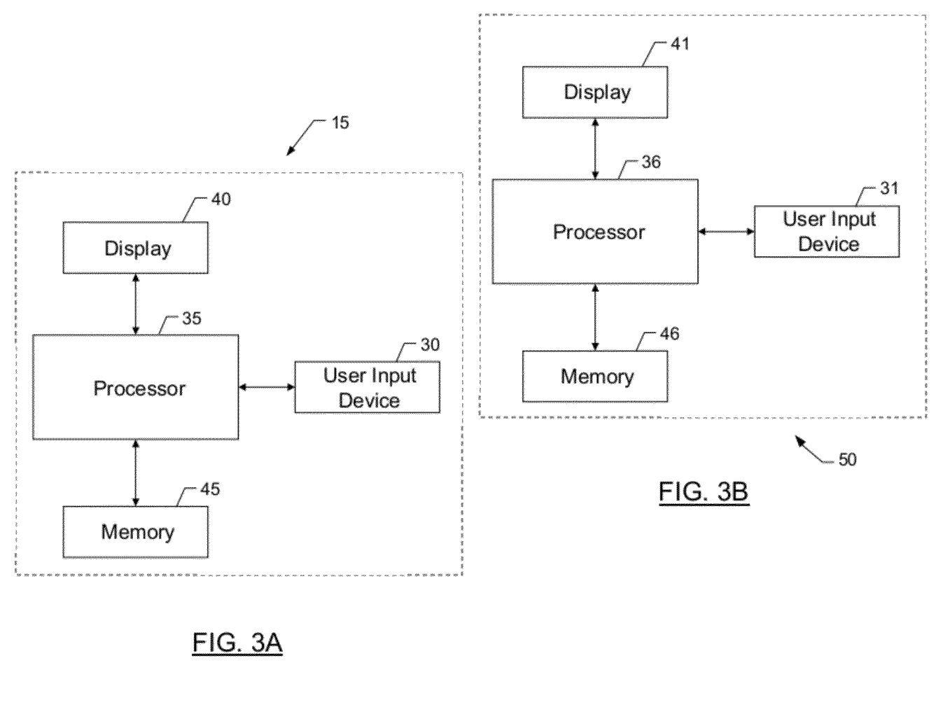

With reference to FIG. 3A, each station 15 may include a user input device 30, a processor 35, and a display 40. A user, such as a physician, wishing to view information regarding a certain drug may interface with the input device 30 to identify himself or herself as an authorized user, select a particular module of the system depending on the type of information the user wishes to view (as described below), and scroll through information presented on the display 40. The user input device 30 may include, for example, a keyboard, a mouse, a bar code reader, an RFID reader, or a combination of these devices that is configured to receive a User ID (such as the user's name or employee number). The input device 30 may also be configured to receive input from the user selecting a particular module and indicating the name of the drug requested, the therapeutic grouping of the drugs, a patient's name or other patient identifier, or other details regarding the drug or treatment of interest and/or the patient to whom the drug is to be administered.

The processor 35 may be configured to communicate with the input device 30 and the display 40 of the station 15 so as to cause the display to solicit from and present to the user certain information. For example, the display 40 may prompt the user to enter a password via the input device 30 upon receiving an authorized User ID as a second layer of security. The display 40 may present the user with various modules of operation from which the user may select. The information received from or presented to the user during the user's interaction may be stored in a memory 45 of the station 15.

Each station 15 may be configured to communicate with a server 50, shown in FIG. 3B. The server can be centrally located, can be distributed, or can be co-located with one or more of the user stations 15. The server 50 may in turn include a user input device 31, a processor 36, a display 41, and a memory 46. The memory 46 of the server 50 may be configured to store a database of drugs, from which data may be extracted and/or manipulated for presentation to the user at the station 15 according to the user's requests. Alternatively or in addition to storage of the database on the memory 46, the database may reside on a separate memory or device, and the data may be communicated to the server 50 and/or stored in a memory 46 thereof. For example, data may be uploaded from a data provider's server (e.g., a server located remotely from the server 50 and/or the healthcare facility in general) to the server 50 each night or once a week, such as over a network connection, the Internet, or the Intranet.

With reference to FIG. 3B, the server 50 may include an input device 31, a processor 36, and/or a display 41 for facilitating an auditor's interaction with the server 50 for viewing and analyzing requests for data, as well as modifying the database to, for example, add or change drug names, therapeutic classes, display names, and/or the associations therebetween, as will be discussed in greater detail below.

As noted above, the system may be configured to provide the user with multiple modes of operation from which to choose. For example, the user may be able to select a Prescription Writer Module, via which the user may view a listing of drugs grouped according to embodiments of the method described below to allow the user to determine the appropriate drug to prescribe for a particular patient's condition. As another example, the user may be able to select a Medication Reconciliation Module, via which a list of drugs taken by a particular patient before being admitted to the healthcare facility (e.g., at home) and/or drugs taken by the patient at the facility may be presented to the user to allow the user to develop a listing of drugs, such as a list of drugs to be prescribed to the patient when discharged from the facility, such that duplications and omissions of drugs are avoided.

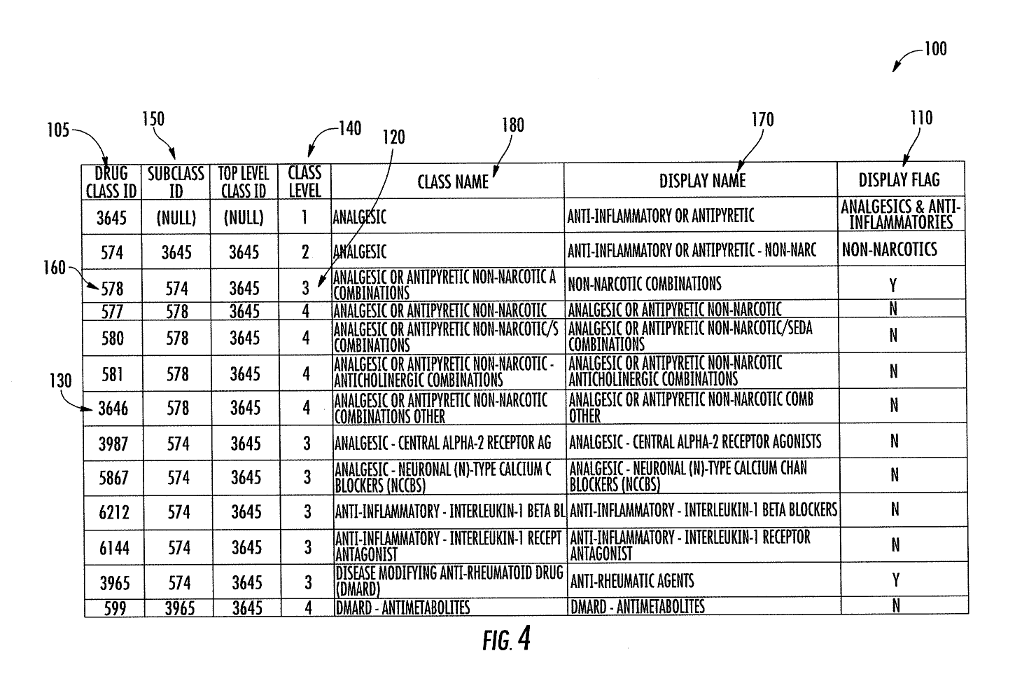

According to embodiments of the methods and systems of managing drug class information described below, a database of drug therapeutic class information is provided that includes, for example, a listing of at least one drug class for each drug, where each drug class describes the drug at a different level of specificity. For example, as depicted in FIG. 4, the processor of the server 50 or the station 15 may be configured to access a database 100 of drug classes according to, for example, the AHFS Pharmacologic-Therapeutic classes. A display name may be associated with each drug class, and a display level may be indicated as the most appropriate level of specificity for describing the particular drug.

For example, a particular drug may have a drug classification identifier 105 of 3646, which may reflect the Tier 4 classification of the drug according to AHFS classification. The drug classification identifier 105 may in some cases be provided by a separate database correlating each drug to a drug classification identifier. Thus, a processor, such as the processor of the station 15 or the server 50, may be configured to locate the row of data corresponding to the particular drug classification identifier and determine whether the corresponding level of specificity is indicated as the display level. The indication of display level may, for example, be a display flag 110 that is associated with each drug class, the display flag being a “Y” or “Yes” if the level of specificity of the corresponding drug class is indicated as the display level and an “N” or “No” if it is not indicated. Thus, the system may apply logic to the accessed database 100 to select the appropriate class by cycling through the listed drug classes for a particular drug, for example from most specific drug class (e.g., Tier 4) to least specific drug class (e.g., Tier 1), to determine the display level.

Taking the example mentioned above, a drug classification identifier of 3646 may point to the row 130, for which the display flag is “N,” meaning that Tier 4 (noted in the column 140 labeled “Class Level”) is not the indicated display level. The processor would then look to the noted subclass 150, which indicates that the program should look to the next class up the hierarchy (Tier 3), which has an identifier of 578. Thus, the program would find the row 160 corresponding to the drug class 578 and look to see if the display flag is a “Y” or an “N.” In this case, the display flag is “Y,” meaning that Tier 3 is the indicated display level 120 for this drug class. In some cases, the top level class, or least specific drug class (Tier 1), may be indicated by default if none of the listed subclasses are indicated as the appropriate display levels. Thus, the lack of indication at the subclass level would serve as the indication of the top level as the display level.

As noted above, each drug class 150 may be associated with a display name 170. The display name 170 may be identical to the AHFS class name for the associated drug class, or the display name may be a name that is more recognizable to healthcare professionals, or more user-friendly, as determined by the provider of the database, the system administrator, or the user's preferences. Continuing the example above, the program would look to the column listing display names 170 to determine what name should be shown to the user to describe the drug at the indicated display level 120. In this example, although the Tier 3 class name 180 is “Analgesic or Antipyretic Non-Narcotic and Combinations,” the class name 170 that would be displayed to the user is “Non-Narcotic Combinations.”

Although a particular database structure and logic have been described in the example above and illustrated in FIG. 4, it is noted that the database may be structured in other ways to indicate a display level and provide a corresponding display name, and other logical steps may be provided to access the given database structure.

Using the framework of the AHFS classification system, an enhanced therapeutic class table may be created that supports the grouping of drugs such that not all drugs are grouped or displayed at the same tier or same level of specificity, but rather that the most appropriate tier or level of specificity is used for each drug. In this way, the indication of a display level for one drug is independent of the indication of a display level for any other drugs, thereby allowing for the most appropriate level of specification to be indicated for a particular drug regardless of the level of specificity required to appropriately describe other drugs. For example, embodiments of the system and method allow for one drug to have an indicated drug class that is at a Tier 4 level of specificity, whereas another drug may have an indicated drug class that is at a Tier 2 level of specificity, with each display level being determined based on the particular drug independently of the determinations made for other drugs.

Accordingly, drugs may be grouped according to the display name, or display level, for reference by the user. For example, the system may receive a requested drug class from the user (e.g., through designation of a particular display name) and may in turn cause to be displayed to the user a list of drugs having a display level that corresponds to the requested drug class, as described in greater detail below. In this way, a user may be able to view all drugs that belong to the same drug class, and the user may be able to determine which of those drugs may be best for prescribing to a patient.

In other embodiments, the system may be configured to receive a patient identifier from the user designating a requested patient and may in turn compile a list of drugs associated with the requested patient. The drug list may, for example, include a first drug or set of drugs reflecting drugs taken by the patient before being admitted to the healthcare facility, or the list may include a second drug or set of drugs reflecting drugs taken by the patient while that patient is at the healthcare facility. The drug list may then be presented to the user along with the display name for each drug on the drug list, reflecting the display level indicated for the particular drug. By grouping the drugs based on the drug class at the indicated level of specificity, the user may easily review the list of drugs to determine if there are drugs on the list that would be duplicative (e.g., if two different drugs are listed that have the same mode of action or treat the same condition, rendering one of the drugs unnecessary), or, alternatively, if any drugs required to treat the patient have been omitted from the list. In some cases, the system may identify drugs listed on the drug list that have a common display level, for example by highlighting any drug class that includes multiple drugs. Thus, by reviewing the drugs listed in any highlighted class, the healthcare professional may be able to determine if any of the drugs are unnecessary and remove them from the patient's drug list.

In some cases, the system may compile a list of drugs that includes both the first drug or set of drugs (e.g., pre-admittance) and the second drug or set of drugs (e.g., in-patient). In this way, the healthcare provider may be able to reconcile the drugs on the combined list in the manner described above to avoid duplications and/or omissions prior to recommending a list of drugs for the patient to take once the patient is discharged from the facility.

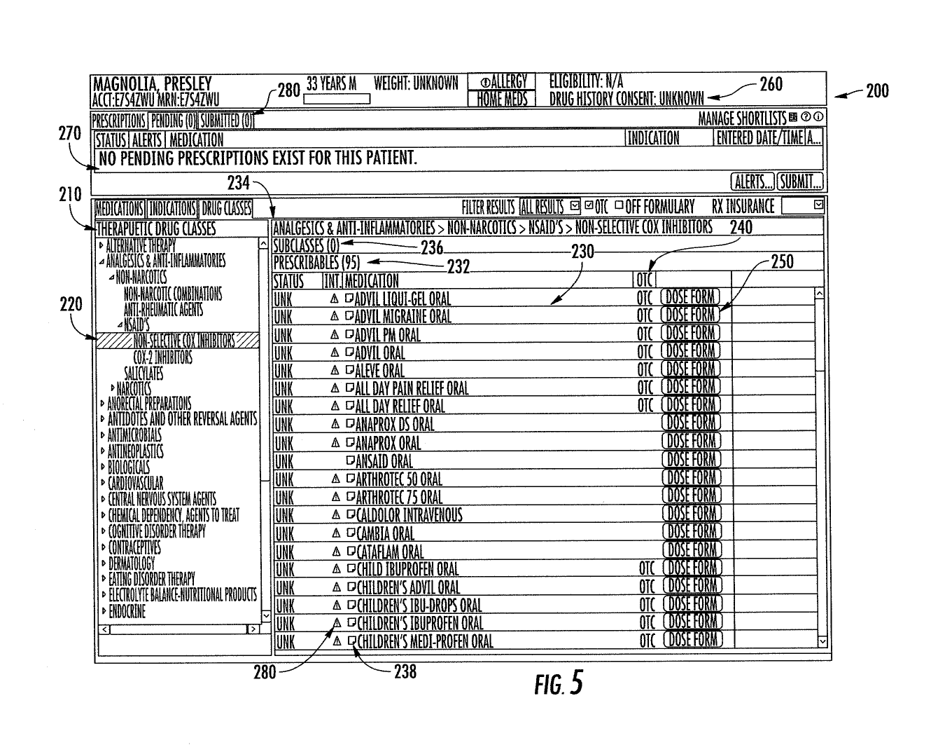

To illustrate, embodiments of the system and method may present the user with the option of selecting either a Prescription Writer Module or a Medication Reconciliation Module, as shown in FIGS. 5-9.

FIG. 5, for example, depicts a screen 200 that may be presented upon the display to a user who selects the Prescription Writer Module. In the Prescription Writer Module, the user may, through interaction with a user input device such as a keyboard or mouse, as described above, enter a requested drug class in order to view a list of drugs for which the display name corresponds to the user requested drug class. For example, the user may be presented with a list of drug classes 210 and may be able to expand certain listed classes and subclasses to select a drug class to view. In some cases, the list of drug classes 210 may include the display name associated with each drug class. In the illustrated case, the user has selected “Non-Selective COX Inhibitors” 220 (the display name for the AHFS class Cyclooxygenase Inhibitors-Non Selective and Combinations), and as a result, a list 230 of drugs for which the display name corresponds to this user requested drug class is presented to the user. The total number 232 of listed drugs may also be shown. In addition, the hierarchy 234 of the requested drug class may be presented to the user to show the top level class and any intermediate subclasses, and a notation 236 regarding any further subclasses available under the requested class may also be presented.

The user may be able to click on an icon 238 next to each listed drug to view more specific drug information, such as its chemical composition, side effects, uses, and other reference information that may be provided by a source such as the AHFS. In addition, a notation 240 may appear next to each drug that is available over-the-counter (OTC) without a prescription, and the user may be able to click on a Dose Form button 250 to view information regarding the available dose forms for each drug.

If the user has designated a particular patient for the transaction, for example by entering a patient identifier, the patient's name may be noted in a window 260 displayed on the screen, along with patient details such as the patient's age, sex, weight, and allergies. Furthermore, any pending or submitted prescriptions for the requested patient may be displayed in another window on the same screen 270 or may be viewable under a separate tab 280. In some cases, the system may display an icon 290 next to any drug which, considering the patient's medical history, for example, may have drug interactions that should be considered by the healthcare professional. Thus, by being able to reference both the patient's details and the drug information through an integrated user interface, the healthcare professional may be able to more easily identify the drugs needed to treat the patient's condition.

Once the user has selected a drug to be prescribed to the patient, the user may click on the drug name or otherwise select the particular drug to have the drug information entered on a prescription pad, which may be displayed as another screen or window for the user's review. The prescription may then either be faxed to a location for dispensing, such as a pharmacy, or may be printed. In addition, the patient information (e.g., patient information stored on the server) may be updated to reflect the addition of the newly-prescribed drug to the patient's list of medication.

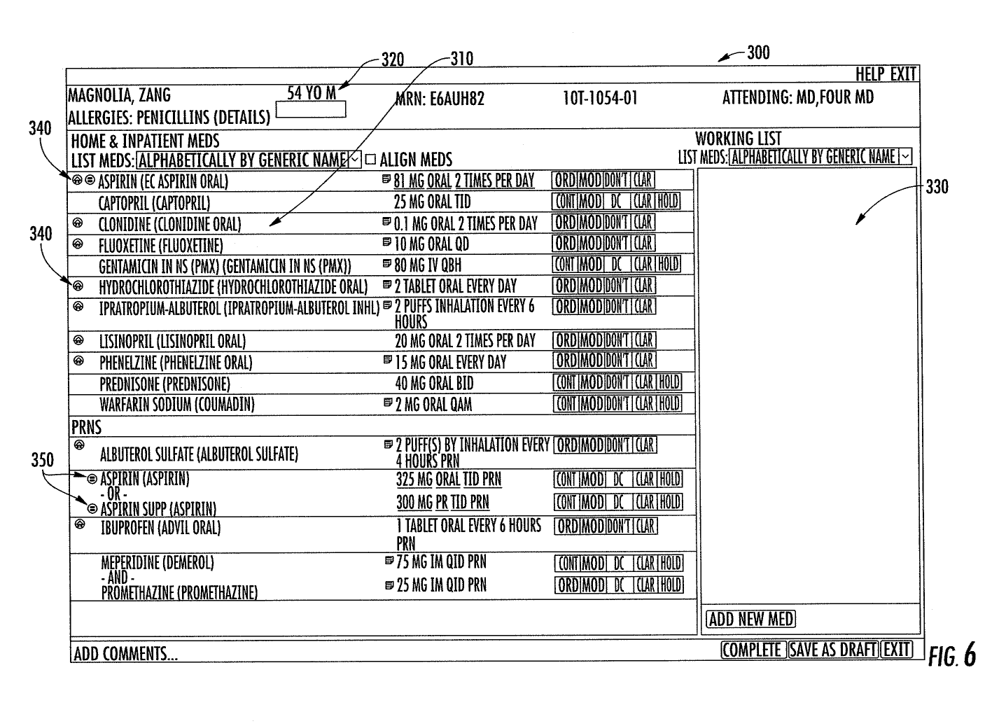

FIGS. 6-9 depict the Medication Reconciliation Module, which may be used to review a list of drugs to be recommended to a patient. For example, the Medication Reconciliation Module may be used to suggest a list of drugs to be continued by a patient upon discharge from the healthcare facility, considering the drugs that the patient had been taking prior to being admitted to the facility and the drugs the patient took while at the facility. The system may be configured to receive a patient identifier from the healthcare professional, such as a patient's name, account number, or identification number. Upon receiving the patient identifier, patient information stored on a memory of the station 15 or server 50, for example, may be accessed for the requested patient. The patient information may include a first drug or set of drugs reflecting drugs taken by the patient before being admitted to the facility and/or a second drug or set of drugs reflecting drugs taken by the patient while the patient is at the facility. In some cases, the patient information may be located in more than one memory and/or in multiple locations.

A list of drugs including the first drug(s), the second drug(s), or both the first and second drug(s) may then be compiled for presentation to the user. In addition, drug information for each drug on the drug list may be accessed. The drug information, which may include the drug classes, for example as classified by the AHFS classification system, and/or the display name associated with the indicated display level, may be stored on the same memory as the patient information or on a separate memory that is likewise accessible by the station's or server's processor. In this way, the drug list, including the display name for the drugs on the drug list, may be presented to the user.

For example, in FIG. 6, a medication reconciliation screen 300 is displayed showing a drug list 310 that includes both the first set of drugs and the second set of drugs. Patient information 320 is displayed at the top of the screen 300, and a window 330 is provided for displaying reconciled drugs (e.g., in this case, the list of drugs to be taken by the patient upon being discharged from the healthcare facility).

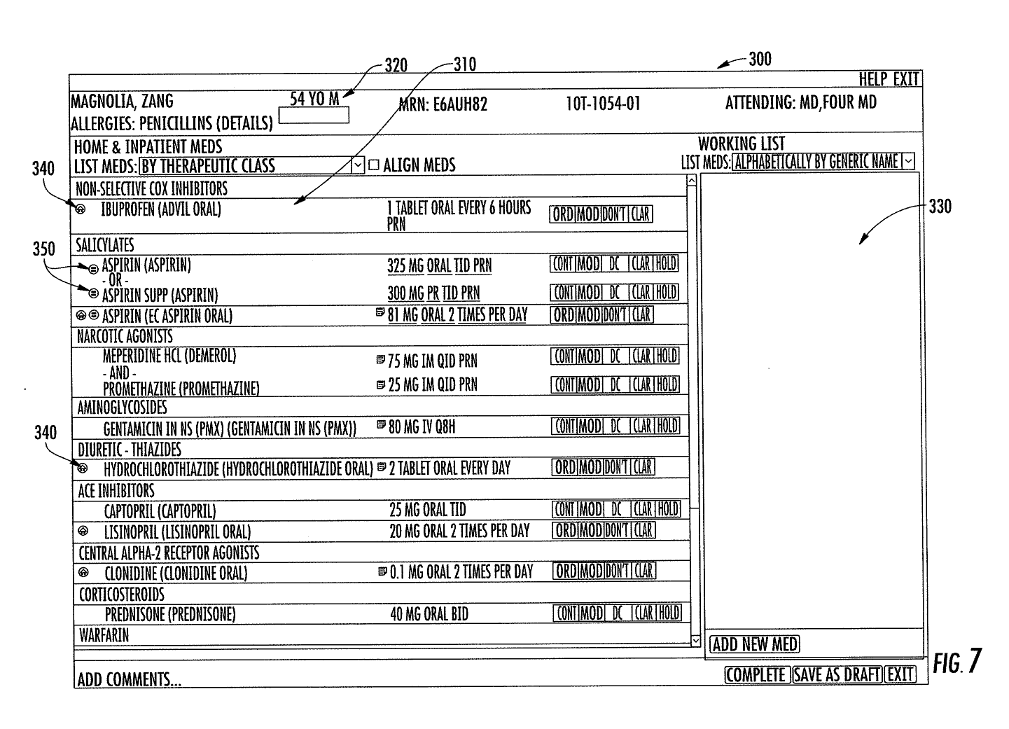

The drug list 310 may be presented to the user alphabetically by the generic name of the drug (FIG. 6), or the user may select an option to display the list by therapeutic class (FIG. 7). Referring to FIG. 7, displaying the drugs in the drug list 310 by therapeutic class in this example allows the healthcare professional to view all drugs taken by the patient before being admitted to the facility and while at the facility (i.e., in-patient) that may be categorized using the same display level. Drugs taken before admittance to the facility (e.g., the first set of drugs) may be visually distinguished from drugs taken while at the facility (e.g., the second set of drugs). For example, an icon 340, such as the image of a house, may be displayed next to each drug that was taken by the patient before admittance to the facility (e.g., at home).

Other indications may also be provided to help the healthcare professional make decisions regarding which drugs to include on the working list of drugs to be recommended to the patient. For example, drugs that appear at more than one location on the list may be denoted with an icon 350, such as an equal sign, as shown for aspirin. The healthcare professional may then decide whether each instance of the drug on the drug list is necessary. In addition, drugs having a common display level may be highlighted by shading the entries or using a different font or color to list those drugs.

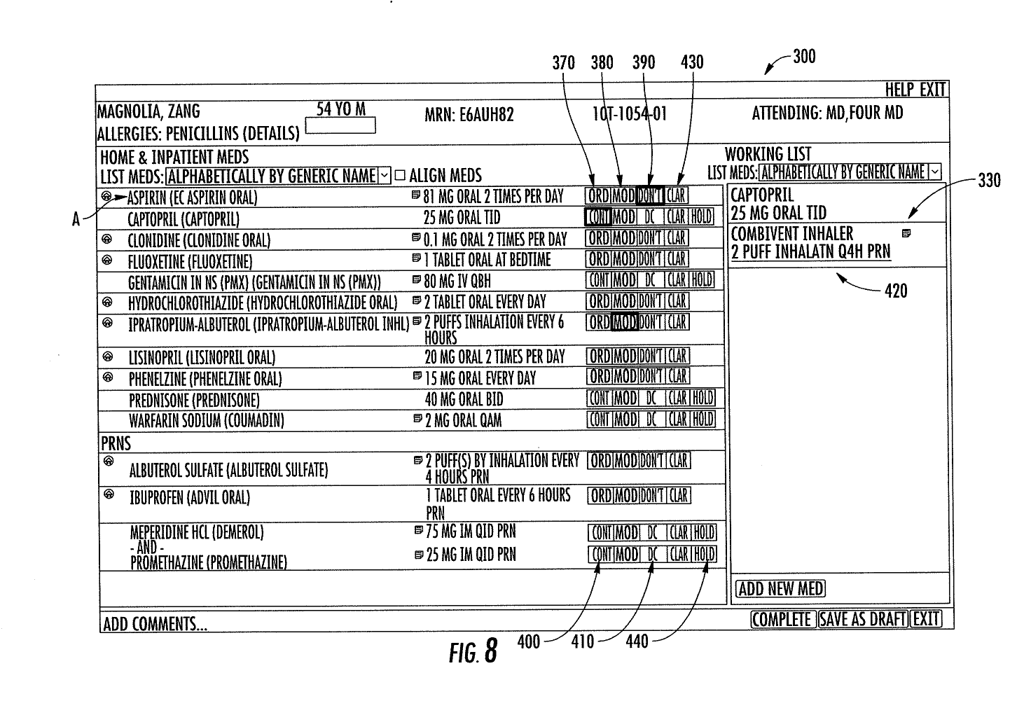

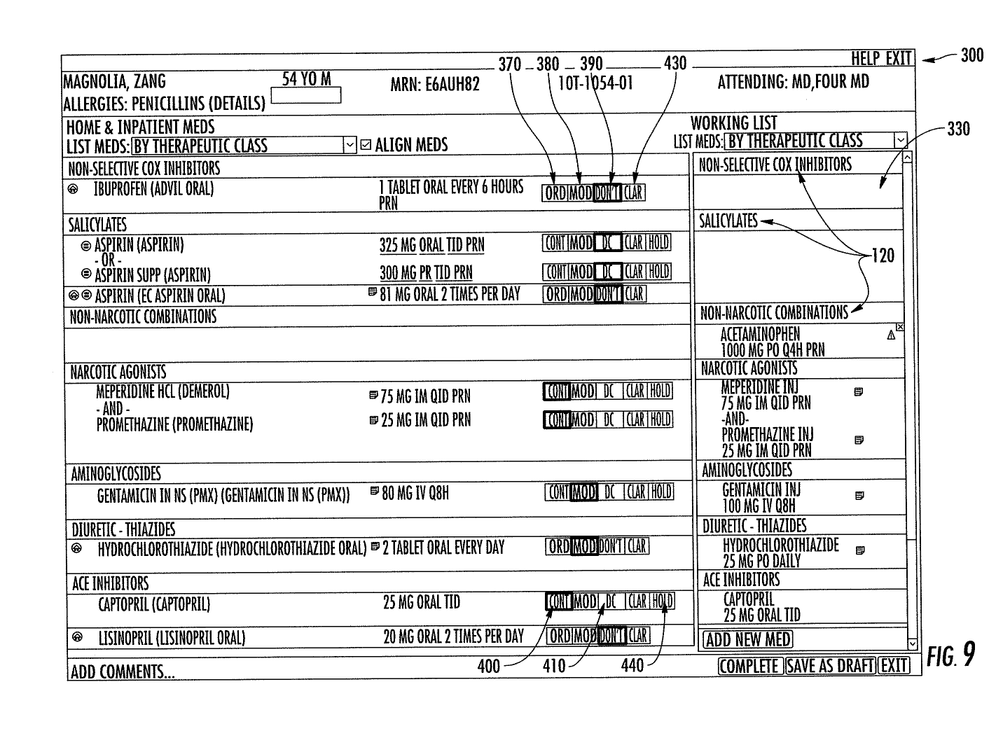

Turning now to FIGS. 8 and 9, buttons 360 may be provided for each drug listed in the drug list 310 that allow the healthcare professional to create a list of drugs for the patient to take, for example, after being discharged from the facility. For drugs belonging to the first set of drugs (i.e., drugs taken by the patient before admittance to the healthcare facility), such as Aspirin shown at entry A in the depicted example, the user may have the option of selecting an Order (“Ord”) button 370 to place an order for the drug, in which case the drug would be added to the working list of drugs 330 to be given to the patient at this level of care. Another option may be to modify part of the listed drug's prescription, such as by increasing the dosage or changing the method of administration. This option may be provided, for example, by a Modify or “Mod” button 380. Still another button, the “Don't” button 390 in the depicted example, may be provided to allow the user to indicate that the drug is not to be added to the working list of drugs.

Other buttons may be provided for drugs belonging to the second set of drugs (e.g., drugs taken by the patient while at the facility). For example, a Continue (“Cont”) button 400 may be selected when the user wants to continue the patient on the drug, which would transfer the drug to the working list 330. Conversely, the Discontinue (“DC”) button 410 may be selected when the user wants to discontinue the drug, in which case the drug would not appear on the working list 330.

Drugs that have been selected for inclusion on the working list 330, but that have been modified by the user (for example via the “Mod” button 380), may in some embodiments be displayed to the user using a different font or color to indicate a change from the originally listed drug. For example, the working list 330 shown in FIG. 8 depicts that the prescribed dosage for the Combivent Inhaler has been changed through the use of underlined font 420.

Additional buttons for providing further functionality to the user may also be included. For example, a Clarify, or “Clar,” button 430 may be provided to allow the user to add a note to be seen and answered by another healthcare professional accessing the system. A physician, for example may notice that the dosage listed for a drug taken by the patient prior to being admitted to the facility may be unreasonably high and may select the “Clar” button 430 to request that the attending nurse verify the dosage with the patient prior to making a determination regarding whether the drug should be included on the working list 330. Likewise, a “Hold” button 440 may be provided for drugs taken on an in-patient basis to indicate that the user does not want the drug to be administered for the time being, but does not want to make a determination with respect to inclusion on the working list 330 until later.

Turning to FIG. 9, the user may do a final check of the working list 330 that has been created based on selections from the drug list 310 by listing the drugs by therapeutic class as opposed to alphabetically. In the depicted example, the user may visually note that no drugs were selected for the drug classes associated with the display names “Non-Selective COX Inhibitors” and “Salicylates,” while the class “Narcotic Agonists” may have more than one drug listed on the working list 330. The working list may thus be further edited by the user, as necessary, to provide an accurate listing of the drugs to be taken by the patient, for example, after discharge from the healthcare facility.

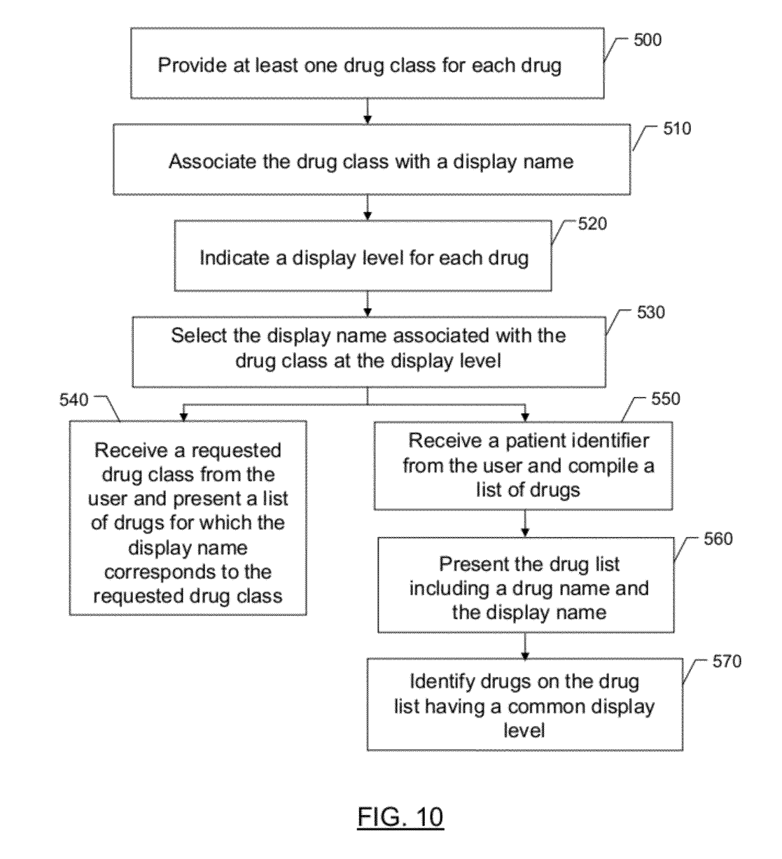

Turning now to FIG. 10, a flow diagram is provided illustrating a method for managing drug therapeutic class information according to the embodiments described above. Initially, at least one drug class is provided for each of a plurality of described drugs, wherein each drug class describes the drug at a level of specificity. Block 500. Each drug class is associated with a display name at Block 510, and a display level is indicated for each drug at Block 520, the indication of the display level for each drug being independent of the indication of the display level for other drugs. The display name associated with the drug class at the display level is selected for display to the user. Block 530.

A requested drug class may be received from the user, such as via a Prescription Writer Module, and a list of drugs for which the display name corresponds to the requested drug class may be presented to the user. Block 540.

Alternatively, in a Medication Reconciliation Module, for example, a patient identifier may be received from the user designating a requested patient, and a list of drugs associated with the requested patient may be compiled. Block 550. The drug list may include a first drug taken by the patient before being admitted to a healthcare facility, a second drug taken by the patient while the patient is at the healthcare facility, or, in some cases, both the first and the second drug. The drug list may be presented to the user including a drug name and the display name for each drug on the drug list, as described above. Block 560. Drugs on the drug list having a common display level may also be identified, such as by a certain font, color, or shading that is applied. Block 570.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus, such as the processor 35, 36, to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, classification systems other than the AHFS classification system may be used as a framework for the databases, and additional functionality with respect to writing prescriptions and reconciling medications may be provided through the user interface. Also, portions of the user interface and underlying data (e.g., the database content) may be modifiable by the user or a provider/administrator of the data to customize the system to meet specific needs of the healthcare facility and/or its users.

In the same way, the presentation of the patient and drug information may be adjusted and configured, for example, to provide a view and/or level of detail that best suits the user's needs. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for managing drug therapeutic class information comprising:
a processor configured to access drug information stored on a memory, wherein the drug information describes a plurality of drugs and the drug information for each drug comprises:
at least one drug class, each drug class describing the drug at a level of specificity;
a display name associated with the drug class, and
an indication of a display level,
wherein the processor is configured to:
access the stored drug information, and
select for display to a user the display name associated with the drug class corresponding to the display level, and
wherein the indication of the display level for each drug is independent of the indication of the display level for other drugs.

2. The system of claim 1 further comprising a user input device in communication with the processor, wherein the user input device is configured to receive a requested drug class from the user, and wherein the processor is configured to select for display to the user drugs for which the display name corresponds to the requested drug class.

3. The system of claim 2 further comprising a display in communication with the processor, wherein the processor is configured to cause display of data upon the display for each selected drug including a drug name and the display name.

4. The system of claim 1, wherein the at least one drug class is based on an American Hospital Formulary Service (AHFS) Pharmacologic-Therapeutic Classification.

5. The system of claim 4, wherein the display name is different from the AHFS Pharmacologic-Therapeutic Classification name of the associated drug class.

6. The system of claim 1, wherein the drug information for at least one drug comprises at least two drug classes including a top level class and one or more subclasses, and the indication of a display level at the top level comprises a lack of indication at the subclass level.

7. The system of claim 1, wherein the drug information is stored on a first memory, wherein the processor is further configured to access patient information stored on a second memory, the patient information including at least one of a first drug taken by a patient before being admitted to a healthcare facility and a second drug taken by the patient while the patient is at the healthcare facility, and
wherein the processor is configured to:
access the stored patient information for a requested patient,
compile a list of drugs including at least one of the first and second drugs,
access the drug information for each drug on the drug list, and
cause display of the drug list to a user, including the display name for each drug on the drug list.

8. The system of claim 7 further comprising a user input device in communication with the processor, wherein the user input device is configured to receive a patient identifier from the user designating the requested patient.

9. The system of claim 7, wherein the processor is configured to compile a list of drugs including the first drug and the second drug.

10. A method of managing drug therapeutic class information describing a plurality of drugs comprising:
providing for each drug at least one drug class, wherein each drug class describes the drug at a level of specificity;
associating the drug class with a display name;
indicating a display level for each drug; and
selecting for display to a user the display name associated with the drug class at the display level,
wherein the indication of the display level for each drug is independent of the indication of the display level for other drugs.

11. The method of claim 10 further comprising receiving a requested drug class from the user and presenting to the user a list of drugs for which the display name corresponds to the requested drug class.

12. The method of claim 10 further comprising receiving a patient identifier from the user designating a requested patient and compiling a list of drugs associated with the requested patient, the drug list including at least one of a first drug taken by the patient before being admitted to a healthcare facility and a second drug taken by the patient while the patient is at the healthcare facility.

13. The method of claim 12 further comprising presenting to the user the drug list, including a drug name and the display name for each drug on the drug list.

14. The method of claim 12, further comprising identifying drugs on the drug list having a common display level.

15. The method of claim 12, wherein the drug list includes the first drug and the second drug.

16. A computer program product comprising at least one computer-readable storage medium having computer-readable program code portions stored therein, the computer-readable program code portions comprising:
a first executable portion configured for accessing drug information stored on a memory, wherein the drug information describes a plurality of drugs and the drug information for each drug comprises:
at least one drug class, each drug class describing the drug at a level of specificity;
a display name associated with the drug class, and
an indication of a display level; and
a second executable portion configured for selecting for display to a user the display name associated with the drug class at the display level,
wherein the indication of the display level for each drug is independent of the indication of the display level for other drugs.

17. The computer program product of claim 16, wherein the at least one drug class is based on an American Hospital Formulary Service (AHFS) Pharmacologic-Therapeutic Classification.

18. The computer program product of claim 17, wherein the display name is different from the AHFS Pharmacologic-Therapeutic Classification name of the associated drug class.

19. The computer program product of claim 16 further comprising a third executable portion configured for receiving from the user a requested drug class, wherein the second executable portion is further configured for selecting for display to the user drugs for which the display name corresponds to the requested drug class.

20. The computer program product of claim 16, wherein the drug information for at least one drug comprises at least two drug classes including a top level class and one or more subclasses, and the indication of a display level at the top level comprises a lack of indication at the subclass level.

21. The computer program product of claim 16 further comprising:
a fourth executable portion configured for accessing patient information stored on a memory, the patient information comprising a first drug taken by a patient before being admitted to a healthcare facility and a second drug taken by the patient while the patient is at the healthcare facility;
a fifth executable portion configured for receiving a patient identifier from the user designating a requested patient;
a sixth executable portion configured for compiling a list of drugs including at least one of the first and second drugs; and
a seventh executable portion configured for displaying the drug list to the user, including the display name for each drug on the drug list.

22. The computer program product of claim 21 further comprising an eighth executable portion configured for identifying drugs on the drug list having a common display level.

23. The computer program product of claim 21, wherein the sixth executable portion is configured for compiling a list of drugs including the first drug and the second drug.
